(19) United States
(12) Patent Application Publication
(10) Pub. No.: US 2007/0149008 A1
(43) Pub. Date: Jun. 28, 2007

(54) Flat cable connector arrangement

(76) Inventor: Thomas Bernhard Pabst, Nurnberg (DE)

Correspondence Address: HARRINGTON & SMITH, PC, 4 RESEARCH DRIVE, SHELTON, CT, 06484-6212, US

(21) Appl. No.: 10/567,045

(22) PCT Filed: Jul. 1, 2004
(86) PCT No.: PCT/EP04/07169

§ 371 Date: Aug. 28, 2006

(30) Foreign Application Priority Data
Aug. 14, 2003 (DE) 10337508.2

(51) Int. Cl. H01R 13/648

(52) U.S. Cl. 439/95

(57) ABSTRACT

The present invention relates to a flat cable plug connector arrangement (1) with a flat cable (2) that has at least one signal conductor (5), at least one ground conductor (6), and a shield (7) surrounding the conductors and with a plug connector (3) having a metal housing (4) and a contact element (8) connected to the signal conductor (5). A grounding jumper (9) that is crimped onto the flat cable (2) and penetrates the shield (7) and the ground conductor(s) (6) is brought into electrical contact with the part of the metal housing (4) on the conductor side by crimping (19) the latter onto the grounding jumper (9).

The present invention relates to a flat cable plug connector arrangement in accordance with the preamble of patent claim 1.

Such flat cable plug connector arrangements are employed when it is of importance to protect a signal conductor from external electromagnetic influences. To this end, the insulated signal conductor is sheathed with a electrically conducting sheath that is connected to ground. In the case of coaxial cables having a round cross section, it is conventional to wind a narrow strip made of aluminum foil in a spiral manner around the insulated signal conductor so as to create the shielding. In the case of flat flex cables, the cable is laid in a sandwich technique between two strips made of a conductor foil—for example, an aluminum foil—and the foils are joined to each other by beading or they are adhesively bonded to each other with a conducting paste.

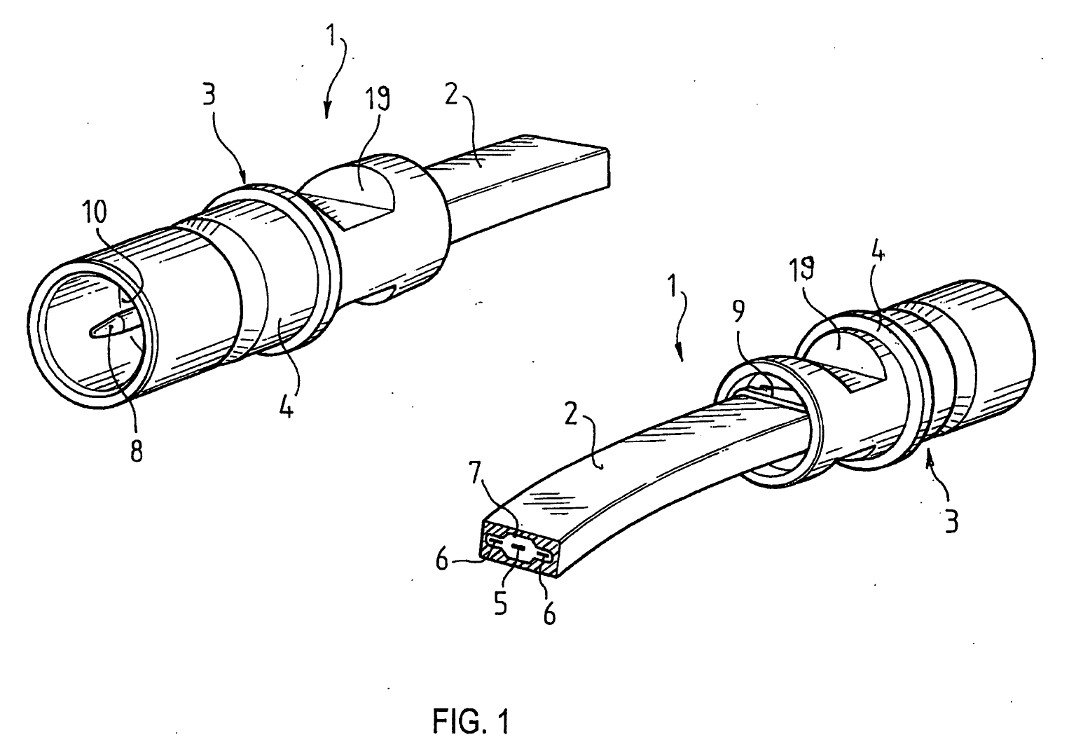

Shown in US 2001/0040043 A1 (FIGS. 1-4) is a flat cable plug connector arrangement with a flexible flat cable that has at least one signal conductor, at least one ground conductor, and a shielding surrounding the conductor and with a plug connector having a metal housing or a housing made of metallized or other conductive material and having a contact element connected to the signal conductor.

Inferred from U.S. Pat. No. 5,021,007 (FIGS. 1, 2, 4-6) in the case of a screened flat cable, furthermore, is the connection of signal conductors and a ground conductor by respective crimping with contact elements.

U.S. Pat. No. 4,500,157 (FIGS. 1, 3, 4, 6-8) shows a connector arrangement having a shielded flat cable, in which an outer shielding and a ground conductor can be connected to a grounding clamp without stripping of insulation by means of a penetration technique.

In DE 2,259,858 A (FIGS. 1-3), in the case of a shielded ribbon cable, the shielding and a ground conductor are contacted by means of a claw-shaped clamping piece, likewise without stripping of insulation (FIG. 1). Provided alternatively for a plug connector is, in addition, the joint contacting of shielding and ground conductor of the flat cable by means of contact points or contact screws that penetrate its insulation.

In the latter technique, it is not always ensured with certainty that the two foils are in good electrical contact with each other. Further, it is important for a good shielding that, at the junction between the ribbon cable and the plug connector, a good electrical conduction is produced and the shielding as well as the plug housing lie securely at ground potential.

The present invention is based on the problem of providing a flat cable plug connector arrangement of the generic kind in which a good electrical connection is ensured, on the one hand, between the different parts of the shielding with respect to one another, the shielding, and the ground conductors and, on other hand, between the plug connector housing, the shielding, and the ground conductor.

This problem is solved in accordance with the features recited in the claim. Characterized in the subclaims are features of preferred embodiments of the present invention.

The present invention is based on the general idea of utilizing electrical crimping connections several times. Thus, on the one hand, a grounding jumper whose contact blade penetrates both the shielding and the ground conductor produces an electrical connection between the latter. Accordingly, the shielding lies at ground potential. At the same time, the plug connector housing made of metal or another electrically conducting material is crimped onto the grounding jumper so that, in this way, this housing also lies at ground potential.

The arrangement of the invention has, in addition, the advantage that, by means of the crimping of the grounding jumper, which in turn is crimped onto the flat conductor, the flat cable is securely held in the plug connector in the housing.

The invention will be explained in greater detail below on the basis of the description of an embodiment example with reference to the drawing. Shown therein is:

FIG. 1 a perspective view of an embodiment of the flat cable plug connector arrangement of the invention;

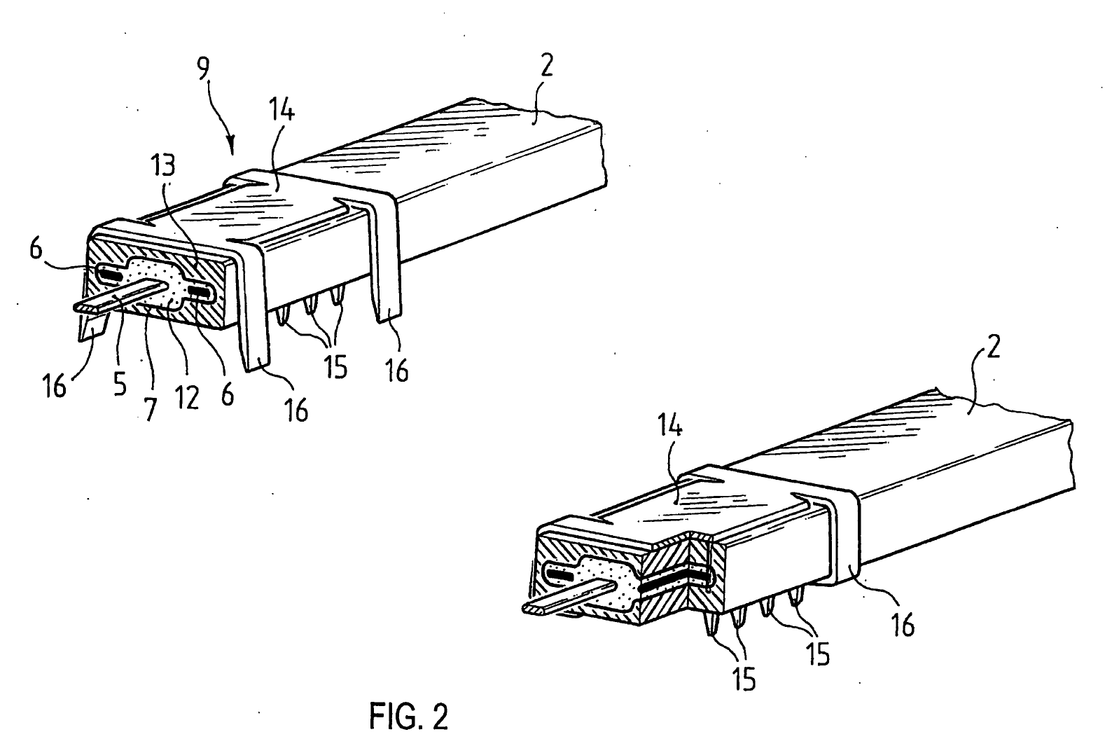

FIG. 2 a perspective partial section through a flat cable having a grounding jumper; and

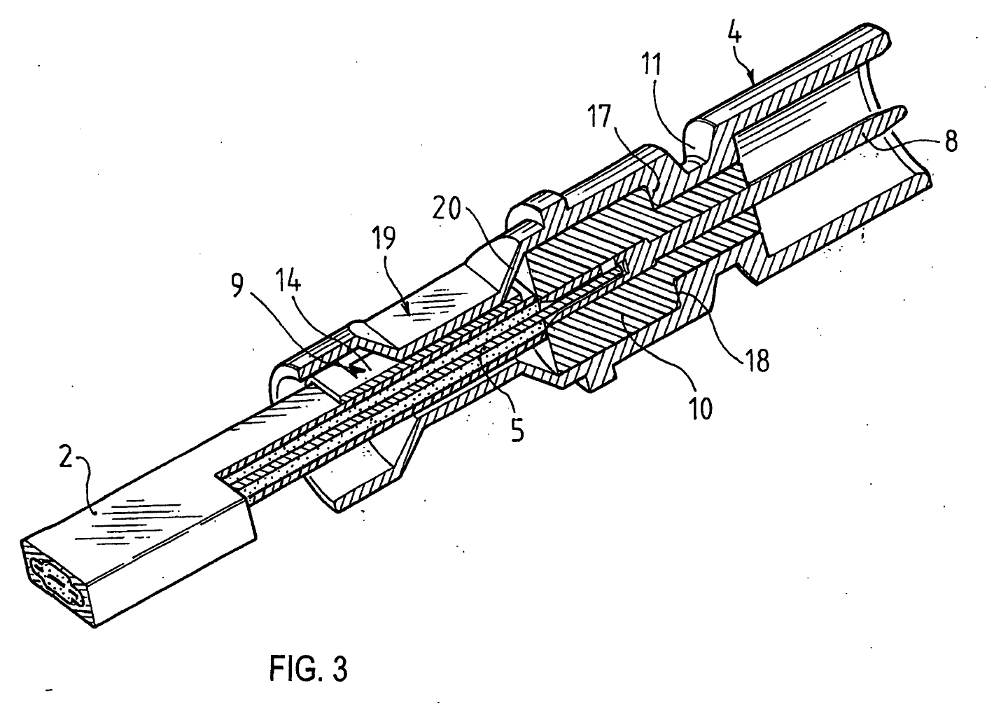

FIG. 3 a perspective view of a longitudinal partial section through a flat cable plug connector arrangement of the invention.

The top view in FIG. 1 shows a flat cable plug connector arrangement 1 viewed at the plug face of the plug connector 3. The latter has a contact element 8 that is mounted in a dielectric insert 10, which is inserted into the plug connector housing 4 with little play. As best seen at the bottom right in FIG. 1, the flat cable 2 has a signal conductor 5, on both sides of which ground conductors 6, also constructed as flat conductors, are encapsulated in a flexible plastic material around which an electrically conducting foil—for example, aluminum foil—is placed as shielding 7; the shielding and the conductor arrangement are in turn encapsulated in a flexible plastic that gives the flat cable its outer shape. Evident in this depiction is also a grounding jumper 9 at the cable-side end of the connector housing 4, which will be described in greater detail below with reference to FIG. 2. It is further evident in FIG. 1 that the metal housing 4 or a housing made of another electrically conducting material is crimped at the level of the grounding jumper 9 onto the latter and onto the flat cable 2. The housing may consist, for example, of a metallized material (e.g., plastic filled with steel fibers) or may have a metal coating on its surface.

FIG. 2 shows two perspective partial sections through the arrangement of the grounding jumper 9 on the flat cable 2. The grounding jumper 9 has a base plate 14 on the edges of which, running parallel to the conductors 5, 6, are formed contact blades 15 that are bent by 90° with respect to the base plate 14. The base plate 14 is sufficiently wide that the contact blades 15 penetrate both the shielding 7 and the ground conductor 6 when the grounding jumper 9 is crimped onto the flat cable 2. This creates, on the one hand, an electrical contact between the bottom part of the shielding and the top part of the shielding 7, which contact, depending on the method of fabrication of the shielding 7, is not ensured with 100 percent certainty. Further, on the other hand, an electrical contact is produced between the shielding 7 and the ground conductors 6, so that the shielding 7 lies securely at ground potential. Further, the ground jumper 14 short-circuits the two ground conductors 6 on the two sides of the signal conductor 5 such that they are kept at the same potential.

The crimping contact blades may be arranged at an angle to the edge of the base plate with respect to their cross extension. In this way, under dimensional tolerances of the individual elements, a secure feedthrough is nonetheless achieved.

The base plate 14 of the grounding jumper 9 has a tab 16 at each of its four ends, which is also bent by 90° with respect to the extension of the base plate 14, namely, in order to embrace the flat cable 2 on its side walls, the tabs 16 being sufficiently long to be bent once more by 90° on the bottom of the flat cable 2, thereby anchoring the grounding jumper 9 firmly on the flat cable 2.

The grounding jumper 9 is placed at the frontmost, unstripped end of the flat cable 2. The stripped signal conductor 5 protrudes sufficiently forward in relation to it that a contact element 8 can be fastened to it, for example, by crimping or soldering.

FIG. 3 shows the arrangement of the flat cable 2, together with the contact elements attached to it, mounted in the plug connector housing 4. The contact element 8, including its connection end with the signal conductor 5, is mounted in the dielectric insert 10. The latter is rotationally symmetric, as is the connector housing 4, and forms, in its front part, a cylinder that is of reduced diameter with respect to its back part, the diameter of which corresponds, with some play, to the inner diameter of the essentially cylinder-shaped plug connector housing. At the level of the front part of the dielectric insert 10, the diameter of the plug connector housing 4 is reduced by a constriction 11, so that the inner diameter of the plug connector housing 4 in the region of the front part of the insert 10 corresponds essentially, with some play, to the diameter of the insert 10 at this point. This results in the formation of a shoulder 17 on the inner wall of the plug housing, against which the shoulder 18 of the insert 10 abuts.

The grounding jumper 9 is located in the back end of the plug connector housing 4. At the level of the grounding jumper 9, the plug connector housing 4 is deformed by crimping in such a way that the inner wall of the housing is in mechanical and electrical contact with the grounding jumper 9 at this site. The contact is produced both on the side of the base plate 14 and on the opposite-lying side, on which, as shown in FIG. 2, the cutting blades protrude out of the flat cable 2, as well as at the level of the bent tabs 16. The crimping region 19 ensures simultaneously that the dielectric insert 10 is fixed in place in the direction opposite to plugging. This occurs via the flanks 20, which are formed in the junction region between the crimping region 19 and the back side of the dielectric insert 10. The flanks on the two sides of the crimping region 19 further form spaces in which the bent tabs 16 are located, so that the deformation of the housing by crimping can extend onto the side lying opposite the base plate 14 up to the surface of the flat cable 2. This results, at the same time, in a securing of the cable, which prevents the flat cable 2 from being pulled out of the plug connector 3.

The assembly of the flat cable plug connector arrangement shown in FIG. 3 can take place in a fully mechanized manner and the result is a mechanically more robust and electrically very well shielded plug connector having a very effective securing of the cable.

1. A flat cable plug connector arrangement with
a flat cable that has at least one signal conductor, at least one ground conductor, and a shield surrounding the conductors and
with a plug connector having a metal housing or a housing made of
metallized or other conductive material and a contact element connected to the signal conductor,
characterized in that
a grounding jumper that is crimped onto the flat cable and penetrates the shield and the at least one ground conductor is brought into electrical contact with the conductor-side part of the housing by crimping the latter onto the grounding jumper.

2. The flat cable plug connector arrangement according to claim 1, further characterized in that the flat cable is constructed as a flat conductor having a flat signal conductor that is encapsulated between two flat ground conductors running at a spacing parallel to it and arranged in a flexible plastic body, which is surrounded by metal foils, which are in turn encapsulated together with the body in an outwardly flexible plastic sheath.

3. The flat cable plug connector arrangement according to claim 1, further characterized in that the grounding jumper has an essentially rectangular base plate, the width of which transverse to the longitudinal direction of the conductor is narrower than the width of the flat cable, in such a way that crimping contact blades, bent by 90° from the side edges with respect to the base plate, bite into the shield and into the ground conductor, and tabs are arranged at the four corners of the base plate that embrace the flat cable up to its side lying opposite the base plate.

4. The flat cable plug connector arrangement according to claim 3, further characterized in that the crimping contact blades are arranged at an angle to the edge of the base plate in their crosswise extension.

5. The flat cable plug connector arrangement according to claims 1, further characterized in that the housing has a dielectric insert, in which the contact element, including its crimping end, is guided.

6. The flat cable plug connector arrangement according to claim 5, further characterized in that the housing and the insert are essentially cylindrical in shape, the front end of the insert, viewed in the plugging direction, having a reduced diameter so as to form a shoulder, which abuts against a contraction in the diameter of the metal housing, the insert being secured on the cable side by the crimping constriction of the metal housing over the grounding jumper.

7. The flat cable plug connector arrangement according to claim 3, further characterized in that the crimping of the housing over the grounding jumper has an extension in the plugging direction that is smaller than or essentially equal to the spacing between the front and back tabs, so that a securing of the cable is effected.

8. The flat cable plug connector arrangement according to claim 3, further characterized in that the tabs are longer than the thickness of the flat cable, so that their ends can be bent around the bottom side of the conductor and the crimping contact blades become pointed at their free ends, their length being slightly greater than the thickness of the flat cable.
